(19) United States
(12) Patent Application Publication
(10) Pub. No.: US 2026/0066268 A1
(43) Pub. Date: Mar. 5, 2026

(54) MIXED METAL AIR BATTERIES

(71) Applicant: AGC Power Inc., Madison, CT (US)

(72) Inventor: Sumeet Gandhi, Madison, CT (US)

(73) Assignee: AGC Power Inc., Madison, CT (US)

(21) Appl. No.: 19/183,671

(22) Filed: Apr. 18, 2025

Related U.S. Application Data
(60) Provisional application No. 63/690,557, filed on Sep. 4, 2024.

(51) Int. Cl. H01M 4/134; H01M 4/02; H01M 10/44; H01M 12/08; H01M 50/103; H01M 50/463; H01M 50/491

(52) U.S. Cl. CPC H01M 4/134; H01M 10/44; H01M 12/08; H01M 50/103; H01M 50/463; H01M 50/491; H01M 2004/021; H01M 2300/006

(57) ABSTRACT

A mixed metal air battery comprises an anode containing at least two metals, which enables the battery to utilize a wide range of metal combinations. The cathode is composed of hydrogen, oxygen, or a mixture of both, allowing for the battery. An electrolyte, in the form of a saturated alkali hydroxide solution, is used to facilitate the flow of ions between the anode and cathode. The electrolyte is in fluid communication with both the anode and cathode, ensuring efficient energy transfer. The battery's design enables it to utilize its anode and cathode materials to generate power, making it a promising alternative to traditional batteries. The combination of metals, gases, and electrolytes creates a unique and efficient energy storage system.

### CROSS-REFERENCE TO RELATED APPLICATIONS

This application claims the benefit of priority to U.S. provisional application No. 63/690,557, filed on Sep. 4, 2025, which is expressly incorporated by reference herein in its entirety.

### BACKGROUND

Metal-air batteries currently face significant implementation challenges primarily centered around recharging difficulties such as dendrite formation, the number of charge and discharge cycles, energy density, anode material loss, and/or cost, to name a few. Furthermore, many of the metals used for anodes can create a fire hazard during use. Metal-air batteries also tend to have an undesired side reaction leading to a hydrogen-evolution reaction, which can then lead to further fire risks, anode dissolution, and lower round-trip efficiency. Accordingly, an anode with improved fire prevention while also providing appropriate energy density is needed.

Metal-air batteries can also experience a loss of the active anode material during operation due to interaction between the anode and the electrolyte as part of the electricity-generating anodic reaction. This gradual loss of material contributes to reduced overall efficiency and further shortens the battery's operational lifespan. Solutions to these and other shortcomings in mixed metal-air batteries are needed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims

FIG. 1 illustrates an example of a mixed metal air battery in accordance with some aspects of the subject matter of the present technology.

FIG. 2 illustrates an example of a mixed metal air battery in accordance with some aspects of the subject matter of the present technology.

FIG. 3 illustrates an example mixed metal anode of a metal air battery in accordance with some aspects of the subject matter of the present technology.

FIG. 4 illustrates an example membrane for a mixed metal air battery in accordance with some aspects of the subject matter of the present technology.

FIG. 5 illustrates an example membrane manufacturing process in accordance with some aspects of the subject matter of the present technology.

FIG. 6 illustrates an example mixed metal air battery in accordance with some aspects of the subject matter of the present technology.

FIG. 7 illustrates an example charge and discharge process for a mixed metal air battery in accordance with some aspects of the subject matter of the present technology.

FIG. 8 illustrates an example testing process for a mixed metal air battery in accordance with some aspects of the subject matter of the present technology.

FIG. 9 illustrates an example of a mixed metal air battery in a carbon capture system in accordance with some aspects of the subject matter of the present technology.

FIG. 10 illustrates a routine 1000 for charging a mixed metal air battery in accordance with one embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Metal-Air Batteries face challenges with their current implementation. For example, typically, metal air batteries have the formation of chemical byproducts that make recharging the battery more costly and more difficult. For example, if zinc is used as part of the anode, a metal-air battery will typically create zinc oxide (ZnO) as the byproduct, which can stay on the surface of the anode. The zinc oxide can also impact the number of recharge cycles available because it leads to the formation of dendrites, which can cause a short in the circuit. When recharging the battery, when there is a build-up of zinc oxide, it takes a considerable amount of energy to reverse the reaction and charge the metal-air battery. Because of this increased challenge of recharging a metal-air battery with zinc oxide formation, the resulting metal-air battery leads to an expensive use case.

Further, metal-air batteries suffer from loss of anode material during use. For example, if zinc is one of the components used in an electrode, there can be dissolution of the zinc into the electrolyte due to the anodic reaction. When this anodic reaction takes place, the zinc becomes soluble in the electrolyte, causing loss of the anode and reducing the efficiency and lifespan of the metal air battery.

Metal-air batteries also suffer from hydrogen evolution reactions at the electrodes, particularly when an aqueous alkaline electrolyte is used, which can cause significant stability issues as well as safety concerns. Hydrogen evolution reactions (HER) can cause the generation of hydrogen gas, which is a known explosive risk. Beyond the safety risks of hydrogen gas buildup, it can also increase the pressure in the battery and cause mechanical stresses to the battery itself. This can damage the battery container, the electrodes, or disrupt the electrolyte. Hydrogen evolution reactions can also cause the degradation of the electrodes, shortening the lifespan of the electrodes, and can cause instability in the electrode itself. Accordingly, an improved metal-air battery can reduce or prevent hydrogen evolution reactions, thereby increasing the safety and lifespan of the battery. One solution is the use of multiple metals in the anode, making a mixed metal-air battery (MMAB).

MMABs can experience safety issues associated with the metals in the MMAB. For example, in an MMAB, lithium is known to have good energy density, which is outweighed by the fire and explosion risks associated with elemental lithium. Lithium, as one example, can have thermal runaway, causing catastrophic damage to the battery and potentially surrounding structures and workers. Lithium is also highly reactive with the environment, which can cause issues when relying on hydrogen or oxygen as a component of the electrode. Accordingly, mitigating against the explosion risk as well as the reactivity with the environment is needed in improved MMABs.

These issues can be especially prevalent when MMABs are integrated into commercial and industrial processes. For example, the integration of MMABs with a carbon capture system allows for the lowest cost of carbon capture, while allowing the improved carbon capture systems to stand alone, without the need for external electrical input or upgrades at the customer's facility. Accordingly, addressing the issues with MMABs will aid in the reduction of greenhouse gases and make integration into carbon capture systems easier and safer.

This is an exemplary use case because carbon capture technologies typically capture CO₂ from fuel combustion and other industrial sources, which is then either pumped into the ground or converted into products that eventually release the CO₂ back to the environment. Different methods of carbon capture have been tried. However, these previous methods can actually lead to increasing the carbon footprint of the plants where they are installed because they rely on the use of carbon-based power systems, e.g., burning coal for electricity. These systems are not only carbon-intensive but also have capital expenditures and increase the operational costs of the plant because they have a large physical footprint that occupies a large portion of the plant or is adjacent to the plant, and can include significant investment in utility upgrades to run the carbon capture systems. Further, these previous systems can produce significant wastewater and other side products, e.g., nitrous oxide, that have increased disposal and treatment costs. An alternate carbon capture system is needed that includes the use of MMABs that will reduce a system's carbon footprint, not require large storage additions to the process, and provide the energy source to power and operate the carbon capture system.

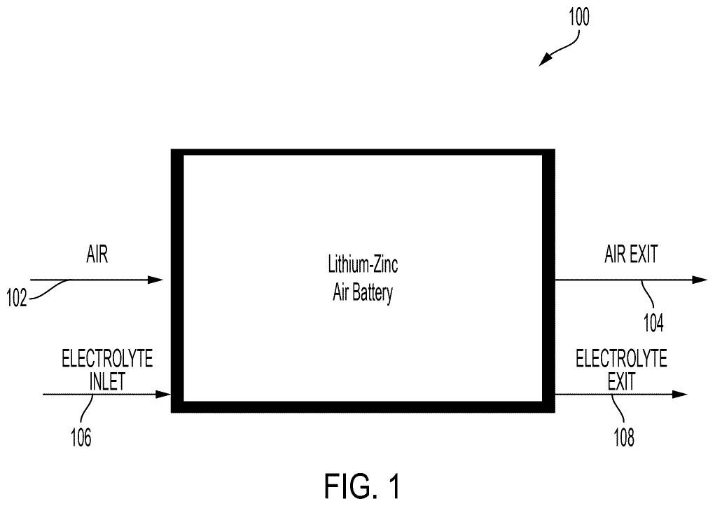

FIG. 1 illustrates an exemplary design of a metal air battery that is consistent with the present disclosure. The metal air battery is provided as an example to aid in describing the present technology. Although a particular arrangement of components is depicted in FIG. 1, the arrangement of such components should not be considered limiting of the present technology unless otherwise specified in the appended claims.

A mixed metal air battery (MMAB) 100 of FIG. 1 can be integrated into industrial, commercial, and consumer-facing products. The operation of MMABs typically involves the electrochemical potential derived from coupling metal oxidation at the anode (e.g., using a mixture of two or more metals) with the oxygen reduction reaction at a catalyzed air cathode during discharge. Electrons released via the anodic process flow through an external load, delivering power, before being consumed in the cathodic reduction reaction. The MMAB will also include an electrolyte to carry the charge created during operation. The electrolyte carries the charge from the anode to the cathode during discharge.

The air for the cathode can by provided by the gas inlet 102 of FIG. 1. The gas inlet 102 can transfer at least air or oxygen into the MMAB. The terms “air” and “oxygen” are used interchangeably throughout this disclosure. The air can operate as the cathode, during discharge, for the MMAB 100 of FIG. 1. The MMAB 100 of FIG. 1 can also utilize hydrogen gas or a combination of hydrogen and oxygen as a cathode during operation.

The anode can be a mixture of metals that have an appropriate energy density for the operation of an MMAB. For example, iron, zinc, sodium, and potassium can be used as components of an anode in an MMAB. Iron, zinc, sodium, and potassium have an energy density of about 1200 to 2700 Wh/kg of metal. Magnesium, aluminum, and lithium, for example, can also be used as components of an anode in an MMAB. Magnesium, aluminum, and lithium have an energy density of about 6500 to 12000 Wh/kg. Accordingly, the combination of some lower energy density components with higher energy density components can create an overall better functioning battery, which increases performance while mitigating risks. For example, the metals can be mixed to create an anode with an energy density in excess of 3000 Wh/kg while mitigating fire risks by mixing low fire risk metals, e.g., zinc, with high energy capacity metals, e.g., lithium. The anode, in addition to being two or more metals, can also include a catalyst to help facilitate the reaction at the anode.

Various anode fabrication methods can be used in creating the mixture of metals for the anode. Such processes include a roll-to-roll process, a solvent method with spray coating, an atomic layer deposition process, a porous or non-porous substrate from Faraday's fabric, conducting polymers, or a nickel or copper substrate, which can be used to form a high surface area layered structure, which will be further detailed below.

Examples for the anode fabrication can include a Solvent Method (Roll-to-Roll process from solvent paste). This method involves making a paste using NMP (N-Methyl-2-Pyrolidine) with PVDF (Polyvinylidene Fluoride) and the metals chosen for the anode, e.g., zinc and lithium. The ratio of zinc and lithium can be varied based on the parameters chosen for the mixed metal air battery. After making the paste, it is rolled onto aluminum or nickel foil, or a conductive, porous, or non-porous substrate.

Another fabrication method is the melt furnace method. Zinc and lithium can be added in ratios, which are then melted (or alloyed) in an inert atmosphere and poured onto a substrate. The weight ratio of the lithium and zinc can be adjusted to make different alloys such as LiZn, œ—LiZn₄, œ—Li₂Zn₅, LiZn₂, œ—Li₂Zn₃, β-Li₂Zn₃, or β-LiZn₄ to some examples of mixtures using the melt furnace method. The formation of these mixtures is based on atomic weight percent and is typically described using the phase. Similar examples can also include mixed metal air alloys fabricated with zinc, sodium, magnesium, lithium, aluminum, iron, and other metals that can be used to fabricate customized mixed metal composite anodes that yield desired energy density.

A further example of a fabrication method includes a catalyst trace additive method. Using this method, a nickel, cobalt, manganese oxide, platinum, palladium, or appropriate catalyst for hydrogenation and oxygen evolution reaction can be used as a trace additive or catalyst to enhance the oxidation-reduction reaction.

The anode can be produced by any of these methods and can include two or more metals to form the anode.

The electrolyte used with the MMAB can be a saturated alkali hydroxide solution or a salt of the metal that is used in the anode. The electrolyte can be, for example, an alkali-based ionic solution, e.g., sodium hydroxide, potassium hydroxide, or lithium hydroxide. These will typically be used as a solution at saturation; it can also be an aprotic organic electrolyte. The salt of the metal used in the electrolyte can be, for example, LiBO₂ when lithium is included as part of the anode. The lithium salt, is an example based on lithium in the anode, however, if aluminum is in the anode, an aluminum salt can be used, similar for iron, magnesium, potassium, as salts related to the metals in the anode do provide advantages when used as an electrolyte, as they can be added as a fire retardant for the electrolyte while preventing or significantly reducing the dissolution of the anode in the electrolyte. Also, by using saturated electrolytes for the MMAB, i.e., the electrolyte is saturated with anode-based metals, the system minimizes water composition in the electrolyte and thereby reduces the hydrogen evolution reaction. The MMABs, consistent with this disclosure, improve the energy density while also reducing fire hazards. The electrolyte, while typically referred to as aqueous, can also be non-aqueous and still function normally within the MMAB.

Examples of non-aqueous electrolytes that can be used with an MMAB include solvents, salts, and additives. Non-aqueous aprotic electrolytes can be included in the MMAB to extend the life cycle of an MMAB; they can also increase high voltage stability, and can be chosen when reactive metals are used that can degrade in aqueous systems. Non-aqueous electrolytes have a wide electrochemical range, being able to stay stable at greater than 4 volts. Non-aqueous electrolytes can also be chosen to suppress dendrite formation, particularly when lithium and zinc are chosen for the anode. Also, due to the low reactivity of non-aqueous electrolytes, they can be used to prevent the formation of passivation layers or at least slow down passivation layer formation. Finally, non-aqueous electrolytes can have reduced water activity, which prevents hydrolysis and hydrogen evolution side reactions.

Exemplary electrolytes for an MMAB can include solvents, salts, and additives. The characteristics of the solvents include being aprotic, polar, having a high dielectric constant, and being low in volatility. Some common solvents are carbonates, ethers, sulfolane, and ionic liquids. Exemplary carbonates include propylene carbonate (PC), dimethyl carbonate (DMC), and ethylene carbonate (EC). Exemplary ethers include tetraethylene glycol dimethyl ether (TEGDME) and dimethoxyethane (DME). Exemplary sulfolane and ionic liquids include high thermal and electrochemical stability.

Exemplary salts that can be used with an MMAB are lithium-based salts, sodium-based salts, zinc-based salts, and magnesium-based salts. For example, lithium-based salts can include, e.g., LiTFSI, LiPF₆, LiClO₄, sodium-based salts can include, e.g., NaClO₄, NaTFSI, zinc-based salts can include, e.g., Zn(TFSI)₂, ZnCl₂ (in hybrid aqueous-non-aqueous systems), and magnesium-based salts can include, e.g., Mg(ClO₄)₂, Mg(TFSI)₂. Additives that can be included in electrolytes include redox mediators (e.g., TEMPO, I⁻/I₃⁻), flame retardants, and film-forming agents.

Some factors that are considered when choosing an electrolyte include, for example, metal compatibility. The electrolyte should be inert to metals chosen for the anode, for example, lithium or aluminum. The electrolyte should have O₂ solubility and diffusivity, which determines the oxygen reduction reaction (ORR) and oxygen evolution reaction (OER) efficiency. The electrolyte should also have stable discharge products to prevent pore clogging on the cathode. Finally, the viscosity and conductivity should be considered when choosing an electrolyte.

There are alternatives for electrolytes that can be considered. For example, hybrid electrolytes, where the aqueous and non-aqueous electrolytes are mixed to balance the conductivity and stability. A solid-state aprotic electrolyte can also be considered, where a polymer or ceramic is used to reduce leakage and flammability. In another example, ionic liquids and deep eutectic solvents can be chosen to provide safer and non-volatile options to facilitate long-term use. Finally, redox mediators can be chosen for electrolytes, which enhance the charge efficiency and reduce overpotentials.

Furthermore, the electrolyte can have additives included that would improve the operation of the MMAB. For example, the electrolyte can have up to 5% by weight of polyethylene oxide (PEO) or polyvinylidene fluoride (PVDF) added. These additives can be included to provide gelation, improving stability in the MMAB. Trace amounts of MnO₂ or Co₃O₄, including as nanoparticles, can be added to help catalyze oxygen reactions. Nickel, palladium, or platinum can also be added to catalyze hydrogenation on the cathode side. Finally, fire retardants can be added to the electrolyte to help reduce or prevent fire hazards associated with MMAB operation.

For example, a fire-retardant based salt, composed of anode-based metal, can be combined with a fire-retardant salt, e.g., if lithium and zinc are used in the anode, a lithium zinc borate can be added to the electrolyte as a fire retardant. Lithium zinc borate is a compound that has fire-retardant properties, where, in the presence of heat, it can release water and form a protective layer that inhibits further combustion. Another example is lithium zincate, which is primarily a source of lithium and zinc ions; its presence in an alkaline solution can help stabilize the environment, potentially reducing the reactivity of lithium and other components. As a fire-retardant, when these compounds are exposed to heat, both lithium zinc borate and lithium zincate can form a glassy layer or a char layer, which can act as a barrier to heat and flame, thereby slowing down any combustion process that has been initiated.

The combination of lithium zincate and lithium zinc borate can also improve the thermal stability of the electrolyte, which can then be used to reduce the likelihood of thermal runaway. When a solution maintains good ionic conductivity, it could still function effectively as an electrolyte while providing fire-retardant properties, which is a benefit of adding these or similar compounds to the electrolyte in MMAB 100. Finally, the compounds in the electrolyte can mitigate the risks associated with lithium's reactivity, which can be used to reduce the overall flammability of the MMAB 100.

Any additions to the electrolyte need to take into account the compatibility with the components of the MMAB. New materials or additives are chosen not to have an adverse effect on the performance of the battery, including its energy density, cycle life, and overall efficiency. The additives, e.g., lithium zincate and lithium zinc borate, also impact the long-term stability and performance of the battery environment, and using additives like those described herein in an MMAB 100 does not degrade or precipitate in ways that could harm battery function. The choice of additives and electrolytes is based on weighing the enhanced fire safety against energy efficiency or battery performance.

In operation, the MMAB can have a gas inlet 102 as shown in FIG. 1. The quality of the air being fed into the MMAB through gas inlet 102 can impact the life span and efficiency of the electrolyte and electrodes of the MMAB. For example, the electrodes of an MMAB can be degraded by the buildup of carbon dioxide in an input stream. Accordingly, if needed, prior to being transferred into the MMAB 100, the air from gas inlet 102 can be conditioned to improve the operation of the MMAB.

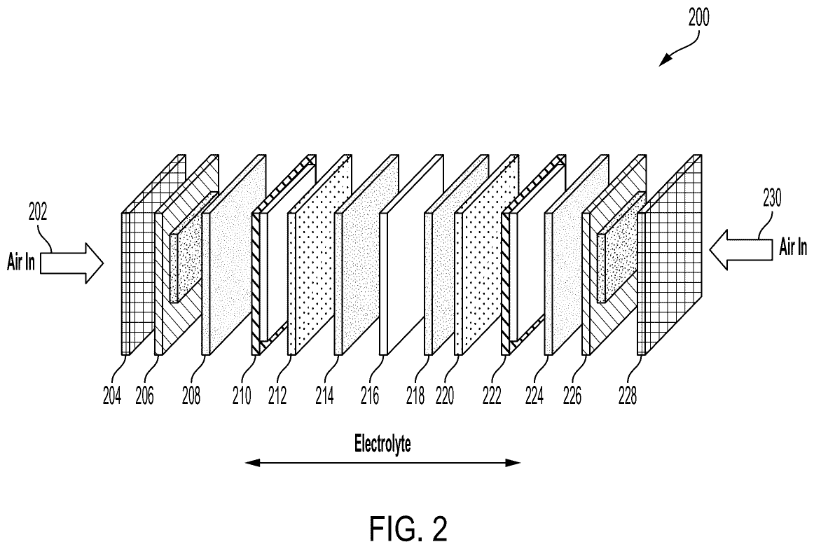

One example of conditioning the air for gas inlet 102 of FIG. 1 is that the air can be dehumidified through a dehumidification process, to remove the moisture from the air, prior to or as part of the process of transferring the air into the MMAB. By conditioning the air prior to transferring it into the MMAB, the impact of any moisture or CO2 buildup can be mitigated. For example, one problem associated with gas inlet 102 is that it has too much moisture. Moisture can cause problems that include diluting the electrolyte, which can change the concentration, conductivity, and other properties of the electrolyte during its use in the MMAB 100. One way to condition the air in gas inlet 102 is to maintain the moisture at a desired humidity level. The humidity level in gas inlet 102 can be kept between 10% and 30% humidity, preferably between 15% and 25% humidity, and most preferably at about 20% humidity. If gas inlet 102 does not include enough moisture, humidity can be added to increase the moisture in gas inlet 102. However, if the gas inlet 102 has too much moisture, then the moisture will need to be removed from gas inlet 102 prior to entering the MMAB to improve operation. While the impact of moisture on the electrolyte is mentioned, the humidity can also impact the cathode diffusion layer, e.g., gas diffusion layer 208 of FIG. 2, and/or the cathode current collector, e.g., current collector 204 of FIG. 2. Each of the cathode diffusion layer and cathode current collector can have the water overwhelm pores, thereby degrading the reaction rate as access to the oxygen is decreased. Finally, the moisture can have an adverse impact on the physical components of MMAB 100, including corrosion, amongst other problems, causing the premature failure of MMAB 100. For these reasons, the air is often conditioned prior to entry into MMAB 100.

Similarly, the air in gas inlet 102 can be conditioned to remove CO₂, as excess CO₂ can also interfere with the optimal operation of MMAB 100. The CO₂ can react with the electrolyte, which will degrade the operation of the MMAB 100. For example, excess CO₂ can deplete hydroxide ions in the electrolyte, which slows down or prevents the electrochemical reactions in the MMAB from moving forward. Another consequence of excess CO₂ in the system can be the formation of precipitates, e.g., K₂CO₃ or Na₂Co₃, from the electrolyte. Because precipitates are undesirable in an MMAB 100, the CO₂ is preferably removed from the air prior to the air entering the system through gas inlet 102. Preferably, gas inlet 102 will have a scrubber or similar apparatus that can remove excess CO₂ from the gas inlet 102, and keep the concentration of CO₂ below 10 ppmv.

In operation, the MMAB 100 will typically include an electrolyte that can enter using electrolyte inlet 106 and will exit the battery at electrolyte exit 108. When using an aqueous electrolyte, the electrolyte will be pumped through the MMAB near or at saturation of the electrolyte. In one example, the electrolyte can be a 6M lithium hydroxide solution or a 6M potassium hydroxide solution. The electrolyte in its saturated state can have a flow rate of from about 0 ml/min up to about 400 ml/min.

In operation, MMAB 100 can have its own independent loop, where a pump is used to circulate the electrolyte and the air is conditioned prior to entering MMAB 100. In a set up as described, the independent loop for the electrolyte, a caustic stream can be pumped through the MMAB, with the stream being refreshed with fresh electrolyte when needed. Electrolyte inlet 106 can also include an electrolyte heater to maintain the feed temperature of the electrolyte, e.g., between 0-100° C. Similarly, the air can be fed through a carbon dioxide scrubber prior to being pumped into the MMAB. This allows the independent circulation of both feeds to keep the gas inlet 102 and electrolyte inlet 106 isolated and conditioned for optimizing the MMAB operation.

The single-cell voltage for the MMAB can achieve between 0 V to 5 V per cell, depending on the type of composite anode used in the MMAB. The operation of the MMAB 100 can also have a current density between 5 mA/cm² to 500 mA/cm² to yield current outputs desired from the battery units. In an exemplary embodiment, the gas inlet 102 can have an air flow between 0 and 4 bar_{g}, while having a temperature of between −20° C. to 100° C., and more preferably from −20° C. to 80° C.

The MMAB can also have a multi-cell configuration, where cells are formed into stacks that can have up to 183 cells, and two stacks can be strung together in series to create a string of battery cells. The number of cells, stacks, and strings can be adjusted to meet the power requirements where the MMABs are being deployed.

A further exemplary embodiment consistent with the disclosure of MMAB 100 is when MMAB 100 operates as a fuel cell. In this example, the mixed metal anode, e.g., iron, zinc, sodium, potassium, magnesium, aluminum, and lithium, can serve as the source for the fuel cell, while oxygen continuously drawn from the ambient air acts as the oxidant. As MMAB 100 discharges, the metal fuel reacts with the oxygen, which can be facilitated by an electrolyte, e.g., potassium hydroxide (KOH) or sodium hydroxide (NaOH), to generate electricity, consuming the metal and forming metal oxides or hydroxides as reaction products.

MMAB 100 of FIG. 1 can also be rejuvenated by replacing or resurfacing the anode. For example, in use, the anode can be consumed during operations, which can be detrimental to the operation of the battery. When the anode needs to be rejuvenated, one option is for the spent anode to be physically removed from the MMAB 100 and replaced with a new or fresh anode. The spent anode can then be regenerated or renewed via reversing the discharge reactions that consume the anode. This can take place via a recharging reaction, which reverses the discharge reaction of the MMAB. Accordingly, during recharging, the anode can be regenerated. Similarly, the anode can be regenerated or renewed in the MMAB via a recharging reaction, as will be discussed in detail below.

Accordingly, MMAB 100 is a versatile and clean battery for energy production and energy storage.

FIG. 2 illustrates an exemplary design of a mixed metal air battery 200 that is consistent with the present disclosure. FIG. 2 is provided as an example to aid in describing the present technology. Although a particular arrangement of components is depicted in FIG. 2, the arrangement of such components should not be considered limiting of the present technology unless otherwise specified in the appended claims.

In one exemplary embodiment of the present disclosure, the mixed metal air battery 200 can have cathode current collector 204 and cathode frame 226 as the outermost layers of the mixed metal air battery 200, as shown in FIG. 2. The air for the mixed metal air battery 200 comes into contact with the battery at the cathode current collectors 204 and 228. The cathode current collectors 204 and 228 can be used to distribute the electrical charge that is formed from the anode and facilitate the reduction reaction that occurs at the cathode. The cathode current collectors 204 and 228 can also provide structural support for the mixed metal air battery 200 and maintain good contact between the anodes and cathodes of a mixed metal air battery. The cathode current collectors 204 and 228 can also ensure the uniform distribution of the current flows through the electrode to prevent build-up in any one area. This distribution can help increase the lifespan of the electrodes. The cathode current collectors 204 and 228 also provide an interface to provide physical and electrical connections between the mixed metal air battery 200 and an external circuit. The cathode current collectors 204 and 228 can be made of materials that have longer lifespans in the oxidative environment of the cathode. For example, the cathode current collector can be nickel-based, stainless steel-based, titanium-based, or any other material that can function as a current collector.

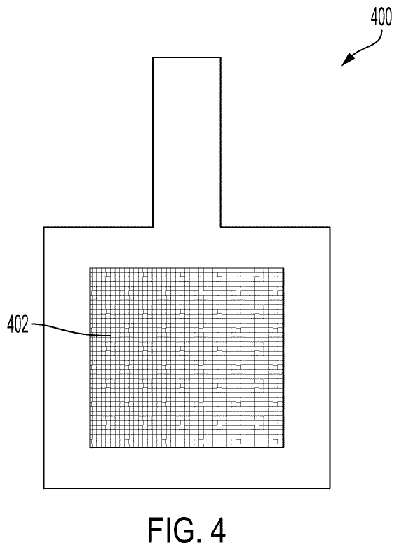

In a further aspect of the present disclosure, FIG. 2 includes cathode frame 206, which helps integrate the gas diffusion layer 208 with the mixed metal air battery 200, and similarly, gas diffusion layer 224 helps integrate cathode frame 226 into the mixed metal air battery 200. The cathode frame is designed to secure the gas diffusion layers 208 and 224 between the cathode current collectors 204 and 228 and their respective anodes 214 and 218. The gas diffusion layers 208 and 224 are often porous materials that benefit from structural support, and that structural support can be provided by the cathode frames 206 and 226. The gas diffusion layer 208 and 224 can be a combination of a membrane with one or more of a catalyst, Faraday's fabric, conductive polymers, and fine conducting particles. The fine conducting particles that can be added increase the surface area of the membrane. The gas diffusion layers 208 and 224 can be a gas diffusion membrane 402, which will be explained in detail with respect to FIG. 4.

In a further aspect of FIG. 2, the mixed metal air battery 200 can include a passivating layer 212 and 220. The passivating layer can be made out of vanadium disulfide, titanium nitride, molybdenum disulfide, tungsten disulfide, carbon based materials, polytetrafluoroethylene (PTFE) or expanded polytetrafluoroethylene (ePTFE). The passivating layers 212 and 220 can also include a metal organic framework (MOF). Suitable MOFs and Derivatives for use as passivating layers can include ziolitic imidazolate framework-8 (ZIF-8), Ni₃(HITP)₂ and Cu₃(HITP)₂, MOF-derived nanomaterials (Post-synthesis annealed), UiO-66-NH₂ or UiO-66-F.

ZIF-8 has a base MOF of Zn²⁺+2-methylimidazole, which is hydrophobic, chemically robust, with good proton blocking. This is a good choice for water exclusion without hindering ion conductivity. ZIF-8 can be can be grown conformally on metal anodes using solvothermal or spray coating techniques. ZIF-8 can be combined with a composite layer, e.g., TiN or graphene, to improve electrical conductivity.

Another example, is Ni₃(HITP)₂ and Cu₃(HITP)₂. HITP is Hexaiminotriphenylene ligand. These compounds have high electrical conductivity, around 40 S/cm, have crystalline layers, and good charge delocalization. These compounds can provide a charge-conducting interface and can be tuned for water repellence or combined with hydrophobic polymers.

A further example is MOF-derived nanomaterials (post-synthesis annealed). ZIF-67 or MIL-88 can be pyrolyzed to produce carbon-metal composite layers (e.g., Co—N—C, Fe—N—C), and they can form n-doped carbon shells that are hydrophobic, electrically conductive, and chemically inert. These can be used as hydrogen evolution reaction (HER)-resistant layers, for electrocatalysis, and can be used to form ultrathin coatings on the anodes.

A final example is UiO-66-NH₂ or UiO-66-F. These compounds are Zr-based MOFs with excellent chemical and mechanical stability. The surface of these compounds can be tuned via amine or fluorine groups. When hydrophobicity is important, fluorinated versions of these compounds can be preferred, as this can also be used to reduce or prevent HER reactions.

These MOF compounds can be integrated into the MMABs by including them in multilayered or hybrid coatings. For example, a conductive base can be used, e.g., TiN or VS₂, which can ensure charge interaction. Also, the MOFs can be used as an outer layer to restrict mass transport of the water and/or hydrogen. Sandwich structures for the MOFs can also be considered, including using a metal or conductive 2D material (TiN), on top of the MOF layer, which is on top of the electrolyte. Finally, the MOF can be made via thin film deposition techniques like atomic layer deposition (ALD), layer-by-layer (LbL) self-assembly, or electrophoretic deposition, which can help control the thickness, including being able to achieve sub-10 nm thickness.

The passivating layers 212 and 220 of FIG. 2 can also be a layer that forms on the anodes 214 and 218 based on the interaction of the electrolyte with the anode, or can be added layers adjacent to the anodes 214 and 218. As will be discussed in detail below, the unique chemistry of the current disclosure allows for the minimization of the formation of zinc hydroxide and that it can be more efficiently discharged and recharged. The passivating layers 212 and 220 are adjacent to their respective anodes 214 and 218. The anodes 214 and 218 can be zinc, lithium, or aluminum. Between the two anodes, 214 and 218, can be a spacer 216, which can be a substrate with a metal oxide coating. In different embodiments, it is also possible to include a reaction chamber between the anodes, thereby facilitating a different operation of the MMAB under those circumstances. The electrolyte is then able to pass between the anodes 214 and 218 and the gas diffusion layers 208 and 222.

The MMAB 200 of FIG. 2 can also include a mounted ultraviolet and/or infrared light adjacent to the MMAB to facilitate the discharge and recharge reactions, described in detail below.

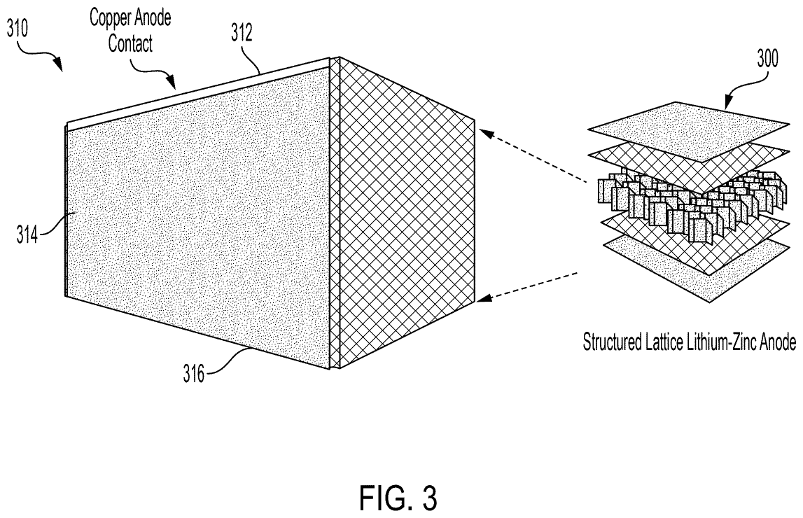

FIG. 3 illustrates an exemplary design of a structured lattice lithium-zinc anode 300 that is consistent with the present disclosure. The structured lattice lithium-zinc anode 300 is provided as an example to aid in describing the present technology. Although a particular arrangement of components is depicted in FIG. 3, the arrangement of such components should not be considered limiting of the present technology unless otherwise specified in the appended claims.

The structured lattice lithium-zinc anode 300 can be used in the mixed metal air battery 200 of FIG. 2 as the anodes 214 and 218 to increase the discharge rate based on the increased surface area of the structured lattice lithium-zinc anode 300 of FIG. 3. Without this lattice structure, the mixed metals have a low depth of discharge because there are metals in the anode that are not used during the charge/discharge cycle. This structure of the structured lattice lithium-zinc anode 300 can also enhance the rechargeability of the mixed metal air battery 200 of FIG. 2. Furthermore, because of the structure, the proportion of the metals in the electrodes that are utilized when generating power is also increased. The structure of the structured lattice lithium-zinc anode 300 can also lead to increased mechanical strength and increase the life of the battery. Each layer of the lattice layer consists of a porous or non-porous substrate, such as copper, nickel, aluminum, or a conductive polymer, on which the mixed metals are electroplated or sprayed to achieve a thickness of 20 to 60 microns.

An expanded sectional view 310 of the structured lattice lithium-zinc anode 300 is also shown to illustrate one example of the structured lattice lithium-zinc anode 300. Expanded sectional view 310 includes the copper anode contact 312, which can operate as the current collector for the mixed metal anode by uniformly distributing any charge that is created. The lithium-zinc scaffold 314 represents the structured lattice of lithium and zinc and is typically in a hexagonal close-packed lattice structure, which provides both its increased surface area and its improved structural stability. Also, due to the close packing of the lithium-zinc in the lithium-zinc scaffold 314, the discharge rate of the lithium-zinc anode 316 is increased. This structure also allows the capacity to increase via stacking multiple anodes together, separated by an insulator to create multiple cells of a mixed metal air battery. These cells can be individual and inches thick, up to multiple cells stacked together, and be six feet or greater in length.

Also, while the exemplary embodiment in FIG. 3 is a lithium-zinc mixed metal air battery, each of the metals identified with respect to FIGS. 1 and 2, e.g., iron, zinc, sodium, potassium, magnesium, aluminum, and lithium, can be used as one of the metals of the multiple metals in a mixed metal air battery consistent with the disclosure of FIG. 3. The metals of a mixed metal air battery can be combined in different ratios and melted or alloyed in an inert atmosphere and poured onto a substrate. Based on the ratio of the mixed metals and the chosen method of combining the mixed metals, the lattice structure can be altered to optimize the surface area, strength, and discharge rate.

In a further embodiment consistent with the present disclosure, in conjunction with or in place of the lithium-zinc scaffold 314, the anode of an MMAB can be coated with a porous or non-porous substrate, e.g., copper, nickel, or a conductive polymer, to create a suitable scaffold for the anode. An additional layer of coating can be added to the anode to minimize anode dissolution and the hydrogen evolution reaction. The coating can be up to 100 nanometers thick. This nanometer-scale coating prevents the charge and discharge processes from reacting with the anode.

FIG. 4 illustrates an exemplary design of a membrane 400 that is consistent with the present disclosure. The membrane 400 is provided as an example to aid in describing the present technology. Although a particular arrangement of components is depicted in FIG. 4, the arrangement of such components should not be considered limiting of the present technology unless otherwise specified in the appended claims.

In one example of the membrane 400 of FIG. 4 is a porous membrane with greater than 20% porosity, more preferably greater than 25% porosity, and most preferably greater than 50% porosity. In one exemplary embodiment, the gas diffusion membrane 402 can have an area of 25 cm² and create 200-300 milliamps per cm². The membrane can be less than 400 microns thick, more preferably less than 200 microns thick. Further, if the membrane is created out of PTFE or ePTFE, then the membrane can be as thin as 10 microns and provide a semi-permeable membrane. In a further example consistent with this disclosure, PTFE can be sprayed onto the gas diffusion membrane 402 to allow for changing thicknesses. Another example consistent with the current disclosure is to create the semi-permeable membrane for gas diffusion membrane 402 out of a binding agent, e.g., PVDF. To increase the surface area of gas diffusion membrane 402, fine conductive particles can be embedded into gas diffusion membrane 402, which will increase its surface area.

One method for improving the porosity of the gas diffusion membrane 402 is to utilize 3-D printing technology. 3-D printing the gas diffusion membrane 402 improves the mechanical strength of the membrane, which allows for the lifespan of the membrane to increase. The gas diffusion membrane 402 also has improved hydrogen flux due to the increased porosity, which improves the efficiency of the hydrogenation reaction. 3-D printing the membrane also increases the case of changing the membrane for different applications, for example, different catalysts can be used for different conditions. 3-D printing also allows the gas diffusion membrane 402 to be created in a design that is appropriate for the MMAB. For example, the gas diffusion membrane 402 can be created to complement the prismatic design of the MMAB by being created as a prismatic gas diffusion membrane 402. It also allows the gas diffusion membrane 402 of FIG. 4 to be coated with a catalyst, carbon, and/or PTFE or ePTFE. Alternatively, the membrane can be constructed out of Faraday's fabric coated with a catalyst and PTFE, a non-woven fabric, or a similar porous membrane that offers a high surface area for ionization of oxygen and hydrogen ions. An additional bonding layer of PTFE with the membrane is performed either through heat press or through roll-to-roll process, this can also be used with the PTFE and fine particles embodiment to create a tightly bound membrane. Furthermore, an additional activated carbon, graphite, or conductive powdered layer may be embedded onto the membrane to increase the surface area either through a powder coating process or through spray coating the membrane.

Furthermore, the gas diffusion membrane 402 can be coated with a catalyst, where the catalyst is specific to each type of MMAB. The gas diffusion membrane 402 for the MMAB can be made of carbon paste with PTFE and a catalyst layer. The gas diffusion membrane 402 can be fabricated from ABS material coated or electroplated with a catalyst layer in addition to a water retardant layer or a film made of material such as PTFE. The gas diffusion membrane 402 can be a 3D printed membrane or fabricated through a plastic injection molding process.

In a further aspect of the disclosure, the gas diffusion membrane 402 can have the catalyst loaded onto the membrane to form a three-phase boundary between the reactants on the anode and the cathode. However, it should be noted that the catalyst may also be added to the liquid reactant(s) or liquid-gas reactants and fed into the MMABs 100 and 200 of FIGS. 1 and 2.

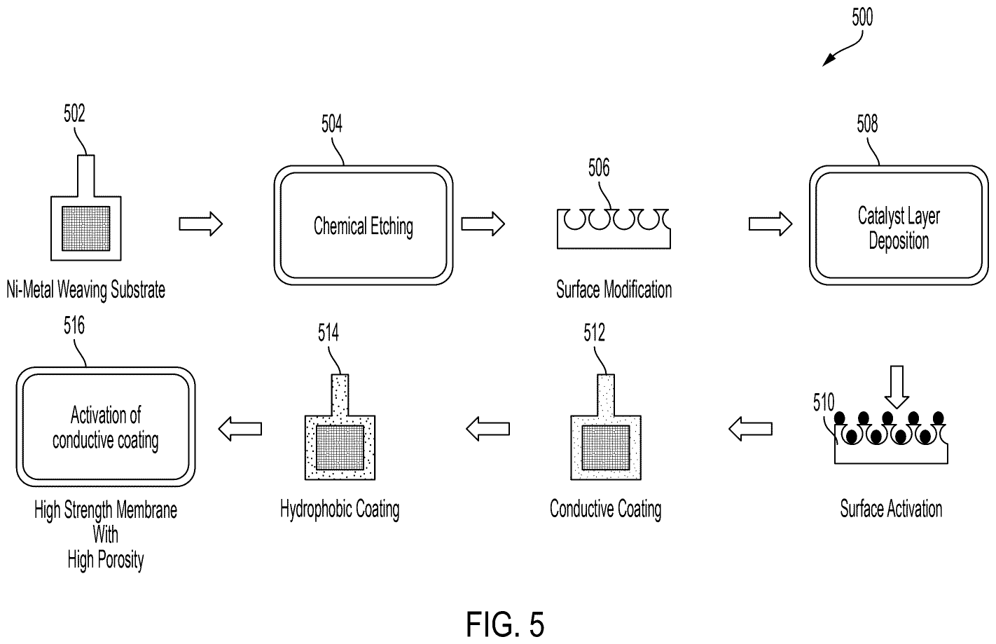

Membrane 400 can be created using 3-D printing to create a single cell structure for the membrane 400. One exemplary process for creating the membrane 400 for use in MMABs 100 and 200 is provided in FIG. 5.

FIG. 5 illustrates an exemplary design process 500 of a membrane 400 that is consistent with the present disclosure. FIG. 5 is provided as an example to aid in describing the present technology. Although a particular arrangement of components is depicted in FIG. 5, the arrangement of such components should not be considered limiting of the present technology unless otherwise specified in the appended claims.

Initially, at one exemplary step of the design process 500, step 502 includes the substrate of the gas diffusion membrane 402 of FIG. 4 being a nickel metal substrate that needs to be prepared for the hydrogenation reaction. The nickel metal substrate can be created via 3-D printing or weaving metal strands together. Some exemplary methods of 3-D printing include metal powder bed fusion, which can include laser melting technology and/or laser sintering. Both of which utilize the underlying metal or alloy, e.g., nickel or nickel alloy, as the basis for building a porous membrane out of the chosen metal.

At a further exemplary step of the design process 500, step 504, the nickel metal substrate is chemically etched to prepare the nickel metal substrate for further modification. For example, the chemical etching can help improve the porosity of the membrane or the pore sizes used in the membrane. This step can also be used to remove any additional preparatory materials used to make the nickel metal substrate. At exemplary step 506, the surface of the nickel metal substrate can be modified using surface modification procedures. This surface modification can include cleaning the surface of any remaining contaminants and can roughen the surface to make the catalyst deposition more robust.

At exemplary step 508, the catalyst can be embedded into the gas diffusion membrane 402 via a deposition process. If the gas diffusion membrane 402 used for the hydrogenation reaction is going to include one of the chosen catalysts, e.g., nickel, titanium, stainless steel, palladium, platinum, iridium oxide, or ruthenium oxide, each can be embedded during this step. After the layer of the catalyst is formed in step 508, in step 510, the catalyst from step 508 is activated. This can take place via calcination, reduction, or electrochemical activation of the catalyst in gas diffusion membrane 402 of FIG. 4. After the catalyst is activated in step 510, in exemplary step 512, a conducive coating is added to the gas diffusion membrane 402. Next, in exemplary step 514, a hydrophobic coating is added, for example, PTFE can be added to the gas diffusion membrane 402. Finally, at exemplary step 516, the conductive coating from step 512 can be activated by electrochemical activation, chemical treatment, or thermal treatment.

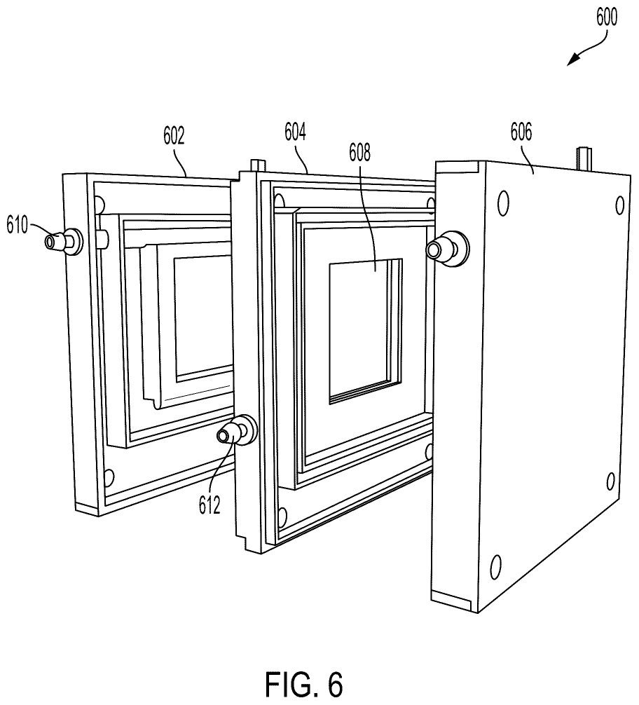

FIG. 6 illustrates an exemplary design of an MMAB 100 that is consistent with the present disclosure. FIG. 6 is provided as an example to aid in describing the present technology. Although a particular arrangement of components is depicted in FIG. 6, the arrangement of such components should not be considered limiting of the present technology unless otherwise specified in the appended claims.

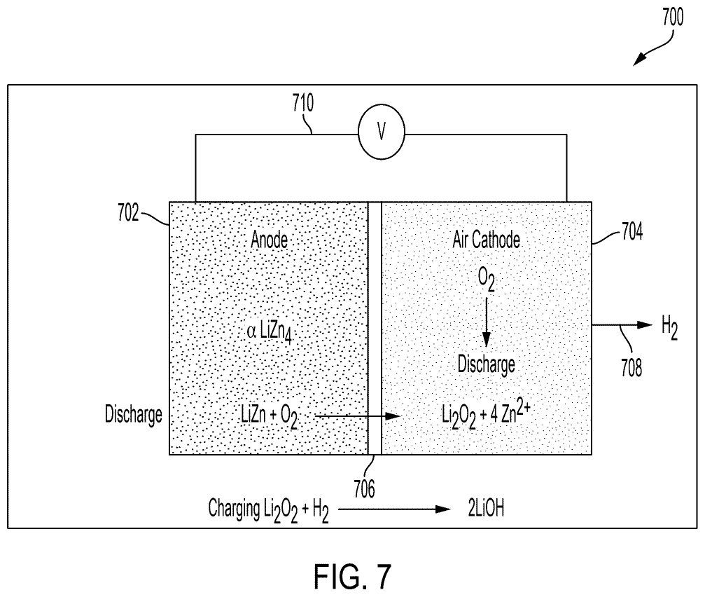

In one example, and as shown in FIG. 6, the MMAB 600 includes a single cell design for an electrolytic reactor. In further examples, multiple cells can be used together to form a multi-cell design of the MMAB 600. Each cell includes an endplate 602 and an endplate 606 that provide the air for the cathode, e.g., gas diffusion layer 208 and 224 of FIG. 2 and cathode 704 of FIG. 7, of MMAB 600. Endplate 602 and endplate 606 represent the opposing ends of the MMAB 600, with the reaction chamber 604 between the two endplates 602 and 606. Alternatively, the multi-cell design for MMAB 600 can include bipolar plates (not shown) to connect multiple cells together. The endplates 602 and 606 can include hydrophobic microporous channels to assist the hydrogenation reaction and distribute the reactants to the catalytic sites in the hydrophilic layer. The surfaces of the endplates 602 and 606 can include a uniform adhesion of a current collector and electrode material for even distribution of potential over the surface of each electrode. In one example, each of the electrodes is electroplated with copper or nickel for use as the current collector, see e.g., FIG. 3. The endplates 602 and 606 can also include a port for adding air and/or hydrogen gas to the MMAB 600. Endplates 602 and 606 can also be used by the MMAB 600 as compression plates to apply force to seal the reactor against leaks.

The prismatic design of MMAB 600 also allows for the chemistry to change when an MMAB switches from a discharge reaction to a charge reaction. The design of MMAB 600 can also minimize electrolyte loss due to the controlled environment of the battery. MMAB 600 can be 3-D printed or can be plastic molded. The material for constructing MMAB 600 can also include materials graphite or carbon fiber that are shaped to the prismatic design. MMAB can also include a dielectric film that is applied to the interior surfaces of MMAB 600 to prevent short-circuiting of the MMAB.

In a further aspect of an exemplary embodiment of MMAB 600, the endplates 602 and 606 can include hydrophilic microporous channels. The hydrophilic microporous channels can include catalyst particles to facilitate the reduction, oxidation, and hydrogenation reactions more efficiently. Exemplary catalysts for use in MMAB 600 include nickel, palladium, platinum, iridium oxide, or ruthenium oxide.

In a further aspect of an exemplary embodiment of MMAB 600, the MMAB 600 can include the reaction chamber 604 between, for example, the endplates 602 and 606. When an aqueous electrolyte is used in MMAB 600, the aqueous electrolyte can enter MMAB 600 through electrolyte inlet 612. The reaction chamber 604 can include a membrane 400 that can be impregnated with a catalyst. The reaction chamber 604 includes a membrane mount 608, where the membrane 400 of FIG. 4 (not shown), for example, can be included in the MMAB 600. The membrane 400 can have a thickness of around 500 microns or less, more preferably around 350 microns or less, and most preferably between 100 and 200 microns. In a further aspect of an exemplary embodiment, the membrane 400 can also include carbonaceous substances and a wet-proofing binder including polytetrafluoroethylene to adjust to a membrane porosity between 15% and 50%, and most preferably between 40% to 50%. The membrane 400 can increase the oxygen flux due to high porosity, and the high porosity can also increase the current density of MMAB 600.

In a further aspect of an exemplary embodiment of MMAB 600, the current density on the membrane 400 can be between 5 to 600 mA/cm², or more preferably in the range of 5 to 400 mA/cm², and most preferably is less than 400 mA/cm² so as to minimize overpotential while managing the rate of reaction.

The MMAB 600 can also include a UV light source and/or an IR light source. The UV light source is preferably in the range of 10 nm to 400 nm, more preferably 40 nm to 400 nm, and most preferably 200 nm to 320 nm. The IR light is preferably in the range of 1.4 μm to 15 μm, more preferably 8 μm to 15 μm, and most preferably 12.5 μm. The UV light source and/or IR light source can be placed at the top of the reaction chamber 604 to conserve energy usage during the discharge and charge reactions. It is also possible to include the UV and/or IR light in the endplates 602 and 606, such that the light is transferable to the reaction chamber.

FIG. 7 represents another exemplary embodiment of the present disclosure. FIG. 7 is provided as an example to aid in describing the present technology. Although a particular arrangement of components is depicted in FIG. 7, the arrangement of such components should not be considered limiting of the present technology unless otherwise specified in the appended claims. Furthermore, while the example below discusses a lithium zinc mixed metal air battery, the membrane technology, fabrication of the anode, and hydrogen/oxygen-based recharging can be applied to Mixed Metal Air Batteries generally, including the anode materials discussed with respect to FIGS. 1 and 2, as well as flow batteries utilizing membranes.

The MMAB discharge reaction is shown in FIG. 7 includes an anode 702, a cathode 704, and a membrane 706, and creates a current through a discharge reaction. In one example of the MMAB 700, an anode 702 is a mixed metal anode that includes zinc and lithium, and is in an αLiZN₄ phase. Furthermore, in the example of FIG. 7, the cathode 704 is air, and the electrolyte can be, for example, an aqueous mixture of potassium hydroxide. While air is one possible cathode, the cathode 704 can also be hydrogen gas or a mixture of hydrogen gas and oxygen. Further, the electrolyte can be any alkali hydroxide or salt of a metal used in the anode, as discussed above with respect to FIG. 1.

The discharge reaction for a lithium-zinc mixed metal air battery is provided below as one possible example of the reaction mechanism for an MMAB, as described in at least FIGS. 1 and 2, and consistent with the present disclosure.

When, for example, the anode includes both lithium and zinc, and both metals are active, then the following reaction mechanism can take place:

At the anode, an oxidation reaction takes place, consistent with the following reaction equation:

LiZn₄→Li⁺+4Zn²⁺+9e⁻

This is based on the oxidation reaction where the lithium creates Li⁺ and e⁻ while the Zn creates Zn²⁺ and 2e⁻. At the cathode, an oxygen reduction reaction takes place, consistent with the following reaction equation, when an aqueous electrolyte is used:

O₂+4e⁻+2H₂O→4OH⁻

In a non-aqueous, e.g., organic, electrolyte, a reaction takes place that is consistent with the following reaction equation:

O₂+2e⁻+2Li⁺→Li₂O₂

The overall reaction equation is consistent with the following:

LiZn₄+O₂→Li₂O₂+4Zn²⁺+electrons

Based on the described exemplary chemical reactions, a current is created from the anode to the cathode. While the example above discusses zinc and lithium, mixtures of two or more of the anode metals are possible and would generally follow similar reaction mechanisms to the ones identified above for zinc and lithium. Furthermore, there are multiple possible phases of metal mixtures that conform to the present disclosure. In one example, the phases for a zinc-lithium MMAB include the phases present between around 0° C. and around 100° C., and around 85% zinc. A phase diagram of a zinc-lithium mixture of around 85% zinc by weight at between about 0° C. up to about 100° C. will be in the LiZn phase, will transition to an αLi₂Zn₃ phase as zinc content increases above 90 weight percent, up to about 92 weight percent, where it transitions to LiZn₂. At around 92 to 93%, the mixture transitions to an αLi₂Zn₅ phase that continues up to around 94%-95% zinc in the mixture. Then, as the zinc increases above about 96% or 97% zinc by weight, the phase enters the αLi₂Zn4 phase. Above about 98% by weight, the phase is dominated by the zinc structure. The phase of the mixed metals chosen for operation will depend on the parameters of the discharge reaction chosen for each situation. When greater capacity is needed and fire risks are lower, an MMAB with greater lithium content can be chosen, whereas where fire retardation is of paramount importance, a higher percentage of the non-flammable metal can be chosen, e.g., zinc in the above example, or other more metals of low flammability, e.g., iron.

The discharge reaction will have the discharge voltages that is related to the metals used in the anode. For example, in a lithium-zinc MMAB, the zinc will have a discharge voltage of around 1.4 volts, and the lithium will have a discharge voltage of around 2.9 volts. If the anode is primarily lithium, then the discharge voltage can be between about 2.5 and 2.9 volts. Whereas if the anode is primarily zinc, the discharge voltage will be between about 1.4 and 1.6 volts. When a synergistic reaction occurs, e.g., multi-electron, then the composite voltage can be between about 1.8 and 2.4 volts.

While this specific example is related to a mixture of lithium and zinc, the metals can be different metals, e.g., iron, sodium, or aluminum. Furthermore, adding hydrogen gas, in addition to or in place of oxygen, can be beneficial for some use cases.

FIG. 7 can also represent the charging reaction of MMAB 700, by reversing the reaction and transitioning the anode to the cathode and the cathode to the anode via the introduction of external power. When FIG. 7 is operated under an oxygen-rich environment, the charging reaction can conform to the following reaction equations.

For the cathode reaction, e.g., oxygen evolution, the charging reaction equation conforms to the following when in an aqueous environment:

4OH⁻→O₂+2H₂O+4e⁻

When the environment is non-aqueous the charging reaction conforms to the following reaction equation:

Li₂O₂→O₂+2Li⁺+2e⁻

For the anode, the charging reaction conforms to the following reaction equation:

Li⁺+4Zn²⁺+9e⁻→LiZn₄

The reaction at the anode is a hydrogen oxidation reaction, and takes place during the charging process. One example of the net reaction equation for the charging process is:

Zn(OH)₂+H₂(g)→Zn+2H₂O(l)

The electrolyte during the discharge and charge reactions can be, e.g., sodium hydroxide, potassium hydroxide, lithium hydroxide, a solid state electrolyte, an organic solvent, or calcium hydroxide. When the electrolyte is, e.g., aqueous potassium hydroxide (KOH), the KOH can carry the OH-ions from what becomes anode 704 to what becomes cathode 702 during charging reactions. The electrons go through the external electrical circuit 710 to complete the reaction.

The charging reaction can also take place under a hydrogen-rich environment, which leads to a different process for charging reactions. In a hydrogen-rich environment, the process can take place chemically instead of using an external circuit that decomposes the 11202. In place of the external power, the hydrogen gas can be used as the reactant to drive the charging reaction. For example, a chemical hydrogenation reaction can take place at the cathode, which conforms with the following reaction equations:

Li₂O₂+H₂→2LiOH

Or

Li₂O₂+2H₂→2LiOH+H₂O(with excess H₂),

Following this reaction, the reaction then takes place as follows:

2LiOH→2Li⁺+2OH⁻+2e−

The electrochemical reaction at the anode conforms to the following reaction equation:

4Zn²⁺+9e⁻+Li⁺→LiZn₄

The hydrogen can act as the electron source, e.g., through a hydrogen oxidation reaction (HOR) at an electrode:

H₂→2H⁺+2e⁻(E°≈0.00 V vs standard hydrogen electrode(SHE))

When the reaction is run in a hydrogen-rich environment, then the hydrogen half-cell HOR at the anode and the Li₂O₂ hydrogenation at the cathode, the cell voltage during the charge can be determined based on the following reaction:

Li₂O₂+H₂→2LiOH

Using this reaction, the Gibbs free energy change (ΔG°) for this reaction can then be used to determine the thermodynamic charging voltage for the reaction. Based on the thermodynamics of the reaction, the ΔG°≈−400 to −450 kJ/mol. This result will depend on the phase of the anode and the temperature of the reaction. Using this ΔG°, the corresponding cell voltage can be calculated as:

E=−ΔG°/nF

Where n=2, because there are 2 moles of electrons transferred per mole of H₂ and F=Faraday's constant≈96,485 C/mol. Based on this calculation, the voltage for the cell is going to be about 2.07 volts. Accordingly, the charging voltage for the MMAB can be about 2 to about 2.2 volts, which is significantly lower than the traditional 3.0-4.2 V needed to electrochemically decompose Li₂O₂ in Li-air batteries.

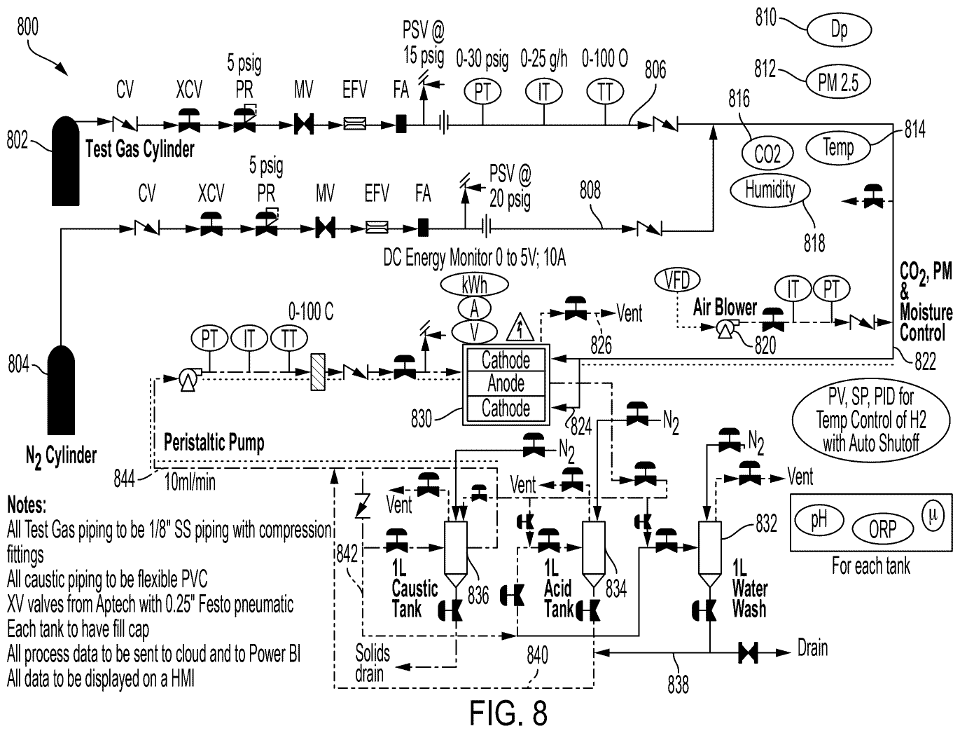

FIG. 8 represents an exemplary embodiment of the present disclosure for testing MMABs. FIG. 8 is provided as an example to aid in describing the present technology. Although a particular arrangement of components is depicted in FIG. 8, the arrangement of such components should not be considered limiting of the present technology unless otherwise specified in the appended claims.

Test environment 800 includes the setup and materials to perform a test under varying real-world conditions to determine the appropriate setup for an MMAB, like those described in FIGS. 1-7. Initially, test gas cylinder 802 and nitrogen cylinder 804 are used to fill the test gas line and the nitrogen gas lines with the test gas and nitrogen, respectively. Each stream can include any combination of a control valve for modulating flow, an XCV valve that can open and close flow through the line, a pressure regulator to regulate the pressure in the line, a motorized valve to control flow in the line, an excess flow valve for safety, a flow alarm to measure if flow is too high or too low, a pressure safety valve to ensure pressure does not exceed a predetermined level. Once the flows are controlled and regulated, they are combined into test gas line 822.

The combined gases in test gas line 822 can then be tested via sensors adjacent to test gas line 822. For example, the test gas line 822 can have a differential pressure sensor 810, a particulate matter sensor 812, a temperature sensor 814, a CO₂ sensor 816, and a humidity sensor 818, and it is also possible to include smoke and fire sensors in the to determine if there are any emergent conditions that need to be addressed by plant operators. The system also includes an air blower 820 as an additional input into test gas line 822, which allows for the control of carbon dioxide, particulate matter, and moisture in the test environment 800.

Test environment 800 then includes a test battery, which can be an MMAB from any embodiment of this disclosure, including MMAB 100, 600, 700. The test battery includes an air input from test gas line 822 for the MMAB as well as a second input, second test gas line 824, for a second cathode of test battery 830. Test gas line 822 can be split into an appropriate number of gas lines to correspond to the number of layers needed for the capacity of the battery. The electrolyte for the test battery 830 is then circulated via electrolyte feed line 844 through the anode of test battery 830, creating a recycle loop to create a continuous test process.

The test battery is monitored for performance, and depending on the measurements related to the differential pressure, particulate matter, temperature, CO₂ levels, and humidity levels, it is possible to determine the performance of the battery under specific conditions. The test environment includes 800 tests for at least a kilowatt hour, the amps, and volts output from test battery 830. By tracking these variables, the battery performance can be calculated, and the battery or environment can be changed to optimize the performance level.

The electrolyte in the electrolyte feed line 844 can be changed as needed, depending on the test results and desired changes. To facilitate different concentrations, flow rates, and the ability to alter other variables, the system needs to be neutralized and cleaned. For that reason, the test environment 800 includes both a water tank 832 and an acid tank 834. Because one type of electrolyte is basic, an acid flush can help neutralize the lines and prevent the buildup of contaminants in the system. For this reason, test environment 800 includes the acid recycle line 842 to facilitate an acid flush of the system and any acid-based test that needs to be run on a test battery. Also, to clean out the lines between tests, there is a wash line 838, which can be used to clean out the lines used for running the tests.

Accordingly, the testing environment allows the variables to be tested and the performance of the test battery to be tested within different environments to determine the best battery conditions for performance.

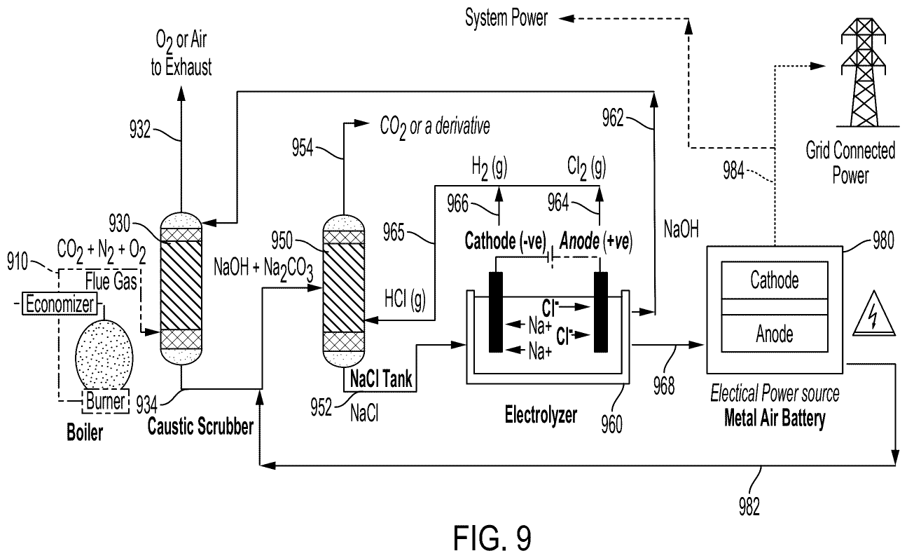

FIG. 9 illustrates a general system for the implementation of a carbon capture system 900. Initially, flue gases from an industrial source can be fed into the carbon capture system 900 as flue gas stream 910. The flue gases or off gases in the flue gas stream 910 include CO2 and other impurities, and it can initially be cooled via an interchanger or similar heat exchanger. The flue gases can be cooled to between 10° C. and 70° C. If further cooling is needed, the intake process can include a secondary cooler. After cooling, the flue gases can be filtered by, for example, a coalescing filter to remove any oil from the flue gases. Finally, the flue gases can be fed into a particulate filter, which can be used to remove fine solids in the stream.

The heat that is removed from the input stream using the interchanger and the secondary cooler can be reused within the system to heat other streams within the carbon capture process. For example, sometimes the caustic used in the process will need an elevated temperature, and/or the caustic that needs regeneration will need to be heated. By recycling the heat from the flue gases fed into the carbon capture system 900, the environmental impact of the system will be reduced, and the economics of the plant will increase.

The flue gas stream 910 is then fed into the caustic scrubber 230, where the CO₂ from the flue gas stream 110 is removed. In the caustic scrubber 230, the flue gases, including carbon dioxide, nitrogen, and oxygen, are contacted with a caustic solution, e.g., sodium hydroxide, potassium hydroxide, or calcium hydroxide, and the CO₂ from the flue gas stream 910 is removed via a reaction with the caustic solution. In the caustic scrubber 230, when the flue gas stream 910 comes into contact with the caustic solution, a reaction occurs between the caustic solution and the carbon dioxide. The reaction will typically take the following form:

CO₂+2NaOH→Na₂CO₃+H₂O

The majority of the carbon dioxide in the flue gases is captured in the caustic scrubber via the above reaction. The stream that includes NaOH, water, and Na2CO3 is diluted and referred to as a lean caustic stream 134 and exits the caustic scrubber 130 through the bottoms product lean caustic stream 934. The distillate 932 is substantially oxygen, nitrogen, and/or carbon monoxide. The distillate 932 can either be further filtered and/or released into the atmosphere.

The lean caustic stream 934 from the caustic scrubber 230 can be fed into a neutralization scrubber 150, where NaOH and Na2CO3 are fed into the neutralization scrubber 150 and reacted with hydrochloric acid, to form NaCl and water along with carbon dioxide. The neutralization scrubber 950 is typically operated from about 20° C. to a slightly elevated temperature of 60° C. The remaining CO₂ that is produced by the neutralization scrubber 950 can be released via CO₂ outlet 954 to the environment or further processed, as will be discussed with respect to later implementations of the present disclosure. The NaCl and water are transferred out via the neutralization scrubber bottoms 952 of the neutralization scrubber 950 to an electrolyzer 960 that can create an electrolyte for MMAB 980, along with hydrogen gas and chlorine gas for the creation of the hydrochloric acid used in the neutralization scrubber 950.

The electrolyzer 960 receives the NaCl and water from the neutralization scrubber bottoms 952 and undergoes a chloralkali process to form hydrogen gas, chlorine gas, and sodium hydroxide. The electrolyzer 960 passes a current through an aqueous solution that includes the NaCl from the neutralization scrubber 950, and electrolysis separates the ions and produces chlorine gas (Cl₂) 964 through an oxidation reaction at the anode and hydrogen gas (H₂) hydrogen gas 966 and sodium hydroxide, through a reduction reaction, at the cathode. The electrolyzer 960 can include a membrane (not shown) to separate the products and facilitate the creation of the products, e.g., sodium hydroxide, hydrogen gas, and chlorine gas.

The hydrogen gas 966 and the chlorine gas 964 can be combined to form hydrochloric acid, HCl stream 965, that can be used in the neutralization scrubber 950 to facilitate the formation of the carbon dioxide for the CO₂ outlet 954 and NaCl for the electrolyzer 960. The sodium hydroxide formed in the electrolyzer 960 can be fed via NaOH stream 962 into the caustic scrubber 230 and used to remove the carbon dioxide from the flue gases. The NaOH stream 962 can be chlorinated by combining it with the chlorine gas 964 from the electrolyzer 960, to additionally create NaOCl, NaCl, and water as byproducts of the reactions. The chlorination reaction will typically be run at low temperatures, e.g., less than 25° C., to prevent the hypochlorite product from decomposing. The NaOH can also be fed into an MMAB 980, via stream 968, where the MMAB 980 can utilize the NaOH as an electrolyte for power production in an MMAB, consistent with the discussions of FIGS. 1, 2, 6, and 7. The MMAB 980 can be used to power the carbon capture system 900, to provide the power to the grid via power line 984, or both. The NaOH from the MMAB 980 can be recycled into lean caustic stream 934 via recycle stream 982 to improve the overall efficiency of the carbon capture system 900.

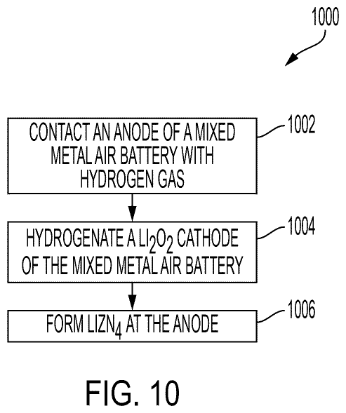

FIG. 10 illustrates an example method for charging the MMABs of FIGS. 1-9. Although the example method depicts a particular sequence of operations, the sequence may be altered without departing from the scope of the present disclosure. For example, some of the operations depicted may be performed in parallel or in a different sequence that does not materially affect the function of the method. Additionally, some of the depicted operations may be optional, and some operations that are not depicted might be part of the method. In other examples, different components of an example device or system that implements the method may perform functions at substantially the same time or in a specific sequence.

In block 1002, routine 1000 contacts an anode of a mixed metal air battery with hydrogen gas. For example, FIG. 7 illustrates an MMAB, consistent with the present disclosure, that can undergo a charging reaction. The charging reaction can also take place in a hydrogen-rich environment. In a hydrogen-rich environment, the process can take place chemically instead of using an external circuit that decomposes the Li₂O₂. In place of the external power, the hydrogen gas can be used as the reactant to drive the charging reaction. During charging operations, the anode of FIG. 7, e.g., anode 702, becomes the cathode for the charging reaction, and the cathode 704 becomes the anode for the charging operations. Accordingly, the air added to the MMAB 700 will come into contact with what becomes the anode 704 during charging operations.

In block 1004, routine 1000 hydrogenates Li₂O₂ at what is the anode of the MMAB, during recharging. For example, the MMAB can undergo a chemical hydrogenation reaction that conforms with the following reaction equations:

Li₂O₂+H₂→2LiOH

Or

Li₂O₂+2H₂→2LiOH+H₂O(with excess H₂),

Following this reaction, the reaction then takes place as follows:

2LiOH→2Li⁺+2OH⁻+2e⁻

The hydrogen can act as the electron source, e.g., through a hydrogen oxidation reaction (HOR) at an electrode:

H₂→2H⁺+2e⁻

When the reaction is run in a hydrogen-rich environment, then the hydrogen half-cell HOR at what becomes the cathode and the Li₂O₂ hydrogenation at what becomes the anode, the cell voltage during the charge can be determined based on the following reaction:

Li₂O₂+H₂→2LiOH

Using this reaction, the Gibbs free energy change (ΔG°) for this reaction can then be used to determine the thermodynamic charging voltage for the reaction. Based on the thermodynamics of the reaction, the ΔG°≈−400 to −450 kJ/mol. This result will be dependent on the phase of the anode and the temperature of the reaction. Using this ΔG°, the corresponding cell voltage can be calculated as:

E=−ΔG°/nF

Where n=2, because there are 2 moles of electrons transferred per mole of H₂ and F=Faraday's constant≈96,485 C/mol. Based on this calculation, the voltage for the cell is going to be about 2.07 volts. Accordingly, the charging voltage for the MMAB can be about 2 to about 2.2 volts, which is significantly lower than the traditional 3.0-4.2 V needed to electrochemically decompose Li₂O₂ in Li-air batteries.

In block 1006, routine 1000 forms LiZn₄ at the anode. For example, the overall charging reaction for MMAB 700 is:

The electrochemical reaction at the anode conforms to the following reaction equation:

4Zn²⁺+9e⁻+Li⁺→LiZn₄

This recharging process, routine 1000, recharges the MMAB 700.

What is claimed is:

1. A mixed metal air battery comprising:
an anode including at least two metals;
a cathode, wherein the cathode is hydrogen, oxygen, or a mixture of hydrogen and oxygen; and
an electrolyte, wherein the electrolyte is a saturated alkali hydroxide solution and is in fluid communication with the anode and the cathode.

2. The mixed metal air battery of claim 1, wherein the anode includes at least lithium and zinc.

3. The mixed metal air battery of claim 2, wherein the lithium and the zinc form αLiZn₄.

4. The mixed metal air battery of claim 1, further comprising:
a catalyst added to the at least two metals.

5. The mixed metal air battery of claim 4, wherein the catalyst is selected from the group consisting of nickel, cobalt, manganese oxide, platinum, and palladium.

6. The mixed metal air battery of claim 1, wherein the at least two metals are selected from the group consisting of iron, zinc, magnesium, aluminum, lithium, sodium, and potassium.

7. The mixed metal air battery of claim 1, wherein the mixed metal air battery has an energy density in excess of 3,000 Wh/kg.

8. The mixed metal air battery of claim 1, wherein the anode is a structured lattice.

9. The mixed metal air battery of claim 1, further comprising:
at least one cell including:
the cathode;
a cathode current collector adjacent to the cathode;
a cathode frame adjacent to the cathode current collector;
a cathode gas diffusion layer adjacent to the cathode frame; and
a passivating layer adjacent to the cathode gas diffusion layer and adjacent to the anode.

10. The mixed metal air battery of claim 9, further comprising:
a dielectric film adjacent to the cathode gas diffusion layer.

11. The mixed metal air battery of claim 1, wherein the electrolyte is one of sodium hydroxide, potassium hydroxide, or lithium hydroxide.

12. The mixed metal air battery of claim 1, wherein the electrolyte further comprises:
about 5 weight percent PEO or PVDF.

13. The mixed metal air battery of claim 1, further comprising:
a porous membrane adjacent to the cathode.

14. The mixed metal air battery of claim 13, wherein the porous membrane is prismatic.

15. The mixed metal air battery of claim 13, wherein the porous membrane is graphite or carbon fiber.

16. The mixed metal air battery of claim 1, wherein the electrolyte further comprises:
at least one of MnO₂, Co₃O₄, nickel, palladium, platinum, or a fire retardant.

17. A method for charging a mixed metal air battery comprising:
contacting an anode of the mixed metal air battery with hydrogen gas;
hydrogenating a Li₂O₂ cathode of the mixed metal air battery; and
forming LiZn₄ at the anode.

18. The method of claim 17, wherein the hydrogen gas is an electron source.

19. The method of claim 17, wherein a charging voltage of mixed metal air battery is between about 2.0 and about 2.2 volts.

20. The method of claim 17, wherein the mixed metal air battery is prismatic.
